(19) United States
(12) Patent Application Publication
(10) Pub. No.: US 2012/0226401 A1
(43) Pub. Date: Sep. 6, 2012

(54) VEHICLE AND CONTROL APPARATUS FOR VEHICLE

(75) Inventor: Masahiro Naito, Anjo-shi (JP)

(73) Assignees: Aisin AW Co., Ltd., Anjo-Shi (JP); Toyota Jidosha Kabushiki Kaisha, Toyota-shi (JP)

(21) Appl. No.: 13/404,300

(22) Filed: Feb. 24, 2012

(30) Foreign Application Priority Data
Mar. 1, 2011 (JP) 2011-043964

(51) Int. Cl. B60W 20/00

(52) U.S. Cl. 701/22; 903/930; 180/65.265

(57) ABSTRACT

A vehicle includes an electric storage device, an internal combustion engine, an electric drive portion that generates a driving force of the vehicle using an electric power from the electric storage device and generates an electric power using a rotational force of driving wheels of the vehicle, and a control device configured to control a driving force from the engine and the driving force from the electric drive portion in a cooperative manner to cause the vehicle to travel. The control device causes the electric drive portion to perform an electric power generation operation to raise a rotational speed of the engine and start the engine, upon receipt of a request to start the engine in a state where the electric power from the electric storage device cannot be used to drive the electric drive portion and a vehicle speed is equal to or higher than a reference vehicle speed.

### INCORPORATION BY REFERENCE

The disclosure of Japanese Patent Application No. 2011-043964 filed on Mar. 1, 2011 including the specification, drawings and abstract is incorporated herein by reference in its entirety.

### BACKGROUND OF THE INVENTION

1. Field of the Invention

The invention relates to a vehicle and a control method for the vehicle, and more specifically, to the control of starting an engine in a hybrid vehicle.

2. Description of Related Art

In recent years, vehicles that are each provided with an electric storage device (e.g., a secondary battery, a capacitor, or the like) to travel through the use of a driving force resulting from an electric power stored in the electric storage device have been drawing attention as environment-friendly vehicles. Examples of such vehicles include, for example, electric vehicles, hybrid vehicles, fuel cell-powered vehicles, and the like. Besides, there have been proposed arts of charging the electric storage device mounted on each of these vehicles with the aid of a commercial electric power supply with high electric power generation efficiency.

Among such vehicles, each hybrid vehicle travels using a driving force generated by an electric rotating machine through the use of an electric power stored in an electric storage device, and a driving force generated by an internal combustion engine. Besides, the internal combustion engine may be started through the cranking of the engine by the electric rotating machine.

In this case, the engine cannot be started when the electric rotating machine cannot be driven due to the occurrence of a malfunction or the like in the electric storage device.

Japanese Patent Application Publication No. 10-234105 (JP-A-10-234105) discloses an art of starting a hybrid vehicle by braking the rotation of a rotor through the use of a magnetic field resulting from an induced electromotive force generated by short-circuiting three phases of a motor-generator, and thereby receiving a reactive force of an engine, when the motor-generator cannot be driven due to a failure in a battery.

The art disclosed in Japanese Patent Application Publication No. 10-234105 (JP-A-10-234105) relates to the control in starting a vehicle when an engine is in an activated state, and is based on a premise that the engine has been started.

Besides, Japanese Patent Application Publication No. 10-234105 (JP-A-10-234105) does not disclose any method of starting the engine when an electric rotating machine cannot be driven due to the occurrence of a malfunction or the like in an electric storage device.

### SUMMARY OF THE INVENTION

The invention makes it possible to start an engine even in the case where an electric rotating machine cannot be driven due to a malfunction in an electric storage device or the like in a hybrid vehicle.

A vehicle according to a first aspect of the invention includes an electric storage device, an internal combustion engine, an electric drive portion, and a control device. The electric drive portion generates a driving force of the vehicle through the use of an electric power from the electric storage device, and generates an electric power through the use of a rotational force of driving wheels of the vehicle. The control device controls a driving force from the internal combustion engine and the driving force from the electric drive portion in a cooperative manner to cause the vehicle to travel. Besides, the control device causes the electric drive portion to perform an electric power generation operation to raise a rotational speed of the internal combustion engine and start the internal combustion engine, upon receipt of a request to start the internal combustion engine in a state where the electric power from the electric storage device is unable to be used to drive the electric drive portion and a vehicle speed is equal to or higher than a predetermined reference vehicle speed.

In the foregoing aspect of the invention, the electric drive portion may include a first electric rotating machine that generates the electric power through use of the rotational force of the driving wheels of the vehicle, and a second electric rotating machine that generates the driving force of the vehicle through use of the electric power from the electric storage device. The control device may cause the first electric rotating machine to perform the electric power generation operation to raise the rotational speed of the internal combustion engine and start the internal combustion engine, upon receipt of the request to start the internal combustion engine in a state where the electric power from the electric storage device is unable to be used to drive the second electric rotating machine and the vehicle speed is equal to or higher than the reference vehicle speed.

In the foregoing aspect of the invention, the control device may cause the second electric rotating machine to consume the electric power generated by the first electric rotating machine when starting the internal combustion engine.

In the foregoing aspect of the invention, the control device may start fuel injection to start the internal combustion engine when the rotational speed of the internal combustion engine becomes equal to or higher than a predetermined threshold.

A control method for a vehicle according to a second aspect of the invention is a control method for a vehicle that includes an electric storage device, an internal combustion engine, and an electric rotating machine, and is caused to travel by controlling a driving force from the internal combustion engine and a driving force from the electric rotating machine in a cooperative manner. The electric rotating machine generates the driving force of the vehicle through the use of an electric power from the electric storage device, and generates an electric power through the use of a rotational force of driving wheels of the vehicle. The control method includes determining whether or not the electric power from the electric storage device is able to be used to drive the electric rotating machine; determining whether or not a vehicle speed is equal to or higher than a predetermined reference vehicle speed; causing the electric rotating machine to perform an electric power generation operation, upon receipt of a request to start the internal combustion engine in a state where the electric power from the electric storage device is unable to be used to drive the electric rotating machine and the vehicle speed is equal to or higher than the reference vehicle speed; and starting fuel injection to start the internal combustion engine when a rotational speed of the internal combustion engine becomes equal to or higher than a predetermined threshold.

According to each of the foregoing aspects of the invention, an engine can be started even in the case where an electric rotating machine cannot be driven due to a malfunction in an electric storage device or the like in a hybrid vehicle.

### BRIEF DESCRIPTION OF THE DRAWINGS

Features, advantages, and technical and industrial significance of an exemplary embodiment of the invention will be described below with reference to the accompanying drawings, in which like numerals denote like elements, and wherein:

FIG. 1 is an overall block diagram of a vehicle according to an embodiment of the invention;

FIG. 2 is a first view for explaining the outline of engine start control;

FIG. 3 is a second view for explaining the outline of engine start control;

FIG. 4 is a third view for explaining the outline of engine start control;

FIG. 5 is a fourth view for explaining the outline of engine start control;

FIG. 6 is a functional block diagram for explaining engine start control that is performed by an ECU in the embodiment of the invention; and

FIG. 7 is a flowchart for explaining the details of an engine start control processing that is performed by the ECU in the embodiment of the invention.

### DETAILED DESCRIPTION OF EMBODIMENT

An embodiment of the invention will be described hereinafter in detail with reference to the drawings. It should be noted that like or equivalent components are denoted by like reference symbols and the description thereof will not be repeated.

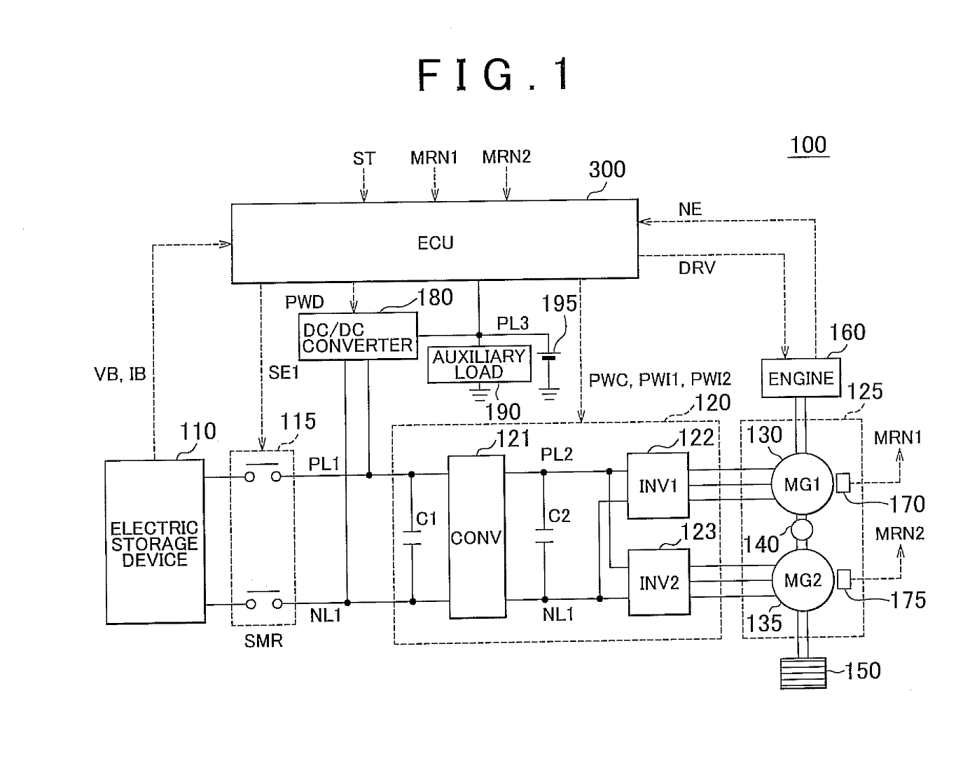

FIG. 1 is an overall block diagram of a vehicle 100 according to the embodiment of the invention. Referring to FIG. 1, the vehicle 100 includes an electric storage device 110, a system main relay (an SMR) 115, a power control unit (a PCU) 120 as a drive device, an electric drive portion 125, a power transmission gear 140, driving wheels 150, an engine 160 as an internal combustion engine, and an electronic control unit (an ECU) 300 as a control device. Further, the PCU 120 includes a converter 121, inverters 122 and 123, and capacitors C1 and C2. The electric drive portion 125 includes motor-generators 130 and 135, and speed detectors 170 and 175.

The electric storage device 110 is an electric power repository element that is configured to be rechargeable. The electric storage device 110 is configured to include, for example, a secondary battery such as a lithium-ion battery, a nickel hydride battery, a lead-acid battery, or the like, or an electric storage element such as an electric double layer capacitor or the like.

The electric storage device 110 is connected to the PCU 120 via an electric power line PL1 and a ground line NL1. Besides, the electric storage device 110 supplies the PCU 120 with an electric power for generating a driving force of the vehicle 100. Further, the electric storage device 110 stores an electric power generated by the motor-generators 130 and 135. The output of the electric storage device 110 is, for example, about 200 V.

The electric power line PL1 and the ground line NL1, which join the electric storage device 110 and the PCU 120 to each other, are provided respectively with relays included in the SMR 115. Besides, the SMR 115 makes a changeover between the supply of electric power and the shutoff of electric power between the electric storage device 110 and the PCU 120, on the basis of a control signal SE1 from the ECU 300.

The converter 121 carries out voltage conversion between the electric power line PL1 and the ground line NL1, and an electric power line PL2 and the ground line NL1, on the basis of a control signal PWC from the ECU 300.

Inverters 122 and 123 are connected in parallel to the electric power line PL2 and the ground line NL1. Each of the inverters 122 and 123 converts a direct-current electric power supplied from the converter 121 into an alternating-current electric power on the basis of a corresponding one of control signals PWI1 and PWI2 from the ECU 300, and drives a corresponding one of the motor-generators 130 and 135.

A capacitor C1 is provided between the electric power line PL1 and the ground line NL1 to reduce fluctuations in the voltage between the electric power line PL1 and the ground line NL1. Further, a capacitor C2 is provided between the electric power line PL2 and the ground line NL1 to reduce fluctuations in the voltage between the electric power line PL2 and the ground line NL1.

The motor-generators 130 and 135 are alternating-current electric rotating machines, for example, permanent magnet-type synchronous motors including rotors in which permanent magnets are embedded.

The output torques of the motor-generators 130 and 135 are transmitted to the driving wheels 150 via the power transmission gear 140, which is configured to include a power splitting mechanism that is represented by a reducer or a planetary gear, so that the vehicle 100 is caused to travel. During regenerative braking operation of the vehicle 100, each of the motor-generators 130 and 135 can generate an electric power through the rotational force of the driving wheels 150. The generated electric power is then converted into an electric power for charging the electric storage device 110, by the PCU 120.

Further, the motor-generators 130 and 135 are coupled to the engine 160 as well via the power transmission gear 140. Besides, the motor-generators 130 and 135 and the engine 160 are operated by the ECU 300 in a cooperative manner, so that a driving force needed to drive the vehicle is generated. Furthermore, each of the motor-generators 130 and 135 can generate an electric power through the rotation of the engine 160 or the rotation of the driving wheels 150, and the electric storage device 110 can be charged using this generated electric power. In this embodiment of the invention, the motor-generator 135 is exclusively used as an electric motor for driving the driving wheels 150, and the motor-generator 130 is exclusively used as a generator driven by the engine 160.

An output shaft of the motor-generator 130 is coupled to a sun gear of a planetary gear (not shown) included in the power transmission gear 140. An output shaft of the motor-generator 135 is coupled to a ring gear of the planetary gear via a reducer. Further, an output shaft of the engine 160 is coupled to a planetary carrier of the planetary gear.

It should be noted that although the configuration in which the two motor-generators are provided is shown as an example in FIG. 1, the number of motor-generators is not limited to two as long as the configuration includes at least one motor-generator that can be caused to generate an electric power by the engine 160. It is also appropriate to adopt a configuration that includes one motor-generator or more than two motor-generators.

The motor-generators 130 and 135 are provided with speed detectors 170 and 175 for detecting rotational speeds of the motor-generators 130 and 135, respectively. Besides, rotational speeds MRN1 and MRN2 detected by the speed detectors 170 and 175 are output to the ECU 300. It should be noted that angle sensors can also be provided instead of the speed detectors 170 and 175. In this case, the ECU 300 calculates the rotational speeds MRN1 and MRN2 of the motor-generators 130 and 135 through computation, on the basis of the detected rotational angles.

The vehicle 100 further includes a DC/DC converter 180, an auxiliary load 190, and an auxiliary battery 195 as a configuration of a low-voltage system (an auxiliary system).

The DC/DC converter 180 is connected to the electric power line PL1 and the ground line NL1, and steps down the direct-current voltage supplied from the electric storage device 110 on the basis of a control signal PWD from the ECU 300. Besides, the DC/DC converter 180 supplies an electric power to the low-voltage system of the entire vehicle such as the auxiliary load 190, the auxiliary battery 195, the ECU 300, and the like, via an electric power line PL3.

The auxiliary load 190 includes, for example, lamp units, a wiper, a heater, an audio system, a navigation system, and the like.

The auxiliary battery 195 is typically constituted by a lead-acid battery. The auxiliary battery 195 can supply an electric power supply voltage to the auxiliary load 190 and the ECU 300. Further, the auxiliary battery 195 can be charged with an electric power from the DC/DC converter 180. The output voltage of the auxiliary battery 195 is lower than the output voltage of the electric storage device 110, and is equal to, for example, about 12 V.

The ECU 300 includes a central processing unit (a CPU), a storage device, and input/output buffers, although they are not shown in FIG. 1. The ECU 300 allows signals from respective sensors and the like to be input thereto, outputs control signals to respective components, and controls the vehicle 100 and the respective components. It should be noted that the control of these components is not limited to a software-based processing, but may also be performed by a dedicated piece of hardware (an electronic circuit).

The ECU 300 calculates a state of charge (an SOC) of the electric storage device 110 on the basis of detected values of a voltage VB and a current IB from a voltage sensor (not shown) and a current sensor (not shown), which are provided in the electric storage device 110.

The ECU 300 acquires from the engine 160 pieces of information including an operation state of the engine 160 that includes an engine rotational speed NE. Further, the ECU 300 acquires a start request signal ST for requesting the start of the engine 160, on the basis of an operation of a user. The ECU 300 generates a control signal DRV on the basis of these pieces of information, and thus controls the engine 160.

It should be noted that although the configuration in which a single control device is provided as the ECU 300 is shown in FIG. 1, it is also appropriate to adopt a configuration in which an individual control device is provided for each function or each component to be controlled, for example, a configuration in which a control device for the PCU 120, a control device for the electric storage device 110, and the like are provided.

In the case where the engine 160 is started in this hybrid vehicle 100, the engine 160 may be cranked by driving the motor-generators 130 and 135 by the electric power of the electric storage device 110.

However, in the case where the electric storage device 110 or the SMR 115 suffers a failure and each of the motor-generators 130 and 135 cannot be supplied with an electric power, the engine 160 cannot be started by driving the motor-generators 130 and 135 through the use of the electric power from the electric storage device 110.

Especially in the case where the supply of an electric power from the electric storage device 110 becomes impossible due to a failure in the electric storage device 110 or the SMR 115 while the vehicle 100 travels using only driving forces from the motor-generators 130 and 135, that is, travels in a so-called electric vehicle (EV) mode, driving forces resulting from the motor-generators 130 and 135 cannot be obtained. Further, the engine 160 cannot be driven either. Therefore, the vehicle stops as soon as the vehicle becomes incapable of traveling through inertia. Then, the vehicle cannot travel in a retreating manner and hence may be stranded on a road.

Further, in the case where the electric storage device 110 or the SMR 115 does not suffer a failure, for example, when the vehicle starts traveling downhill through inertia with the SMR 115 unconnected, the connection of the SMR 115 in this state may lead to the flow of a large current to the SMR 115 at the time of the connection and the adhesion of a contact point of the SMR 115. Therefore, the SMR 115 cannot be connected. Then, none of the motor-generators 130 and 135 and the engine 160 can generate a driving force for driving the vehicle.

Thus, in this embodiment of the invention, even in the case where the motor-generators cannot be supplied with an electric power as described above, when the vehicle travels through inertia, engine start control is performed to start the engine by raising the rotational speed of the engine by the motor-generators through the use of rotational forces from the driving wheels.

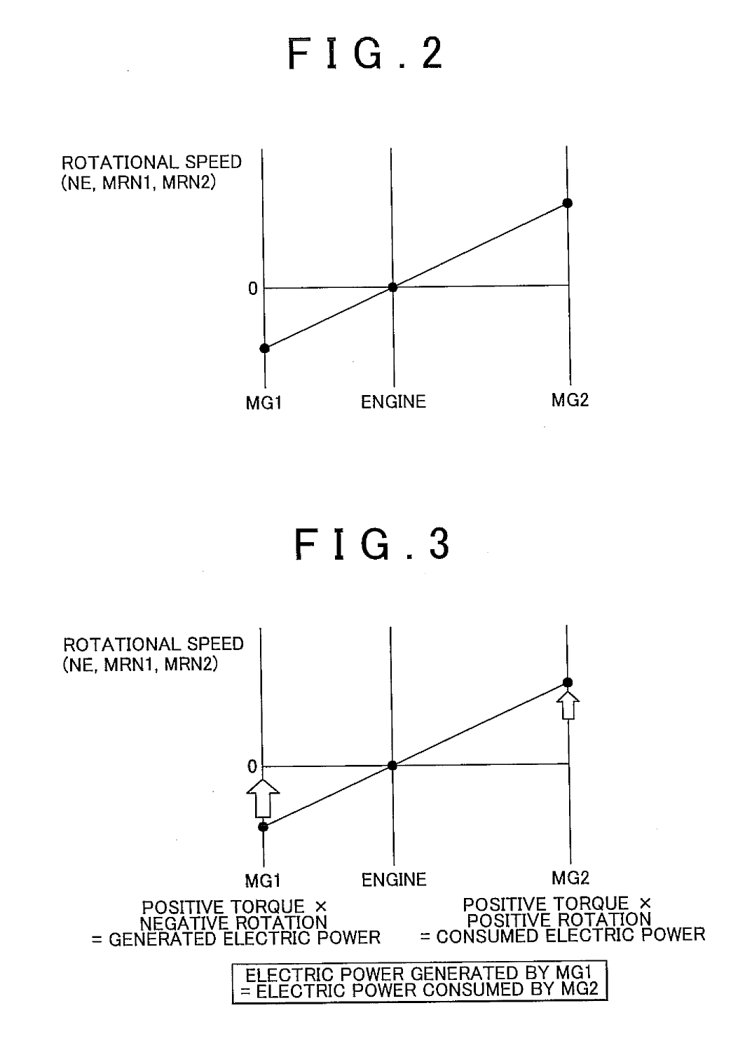

Using collinear diagrams of FIGS. 2 to 5, the outline of engine start control in this embodiment of the invention will be described. As described above, the motor-generators 130 and 135 and the engine 160 are coupled to the sun gear, ring gear, and planetary carrier of the planetary gear respectively.

A case where no electric power from the electric storage device 110 can be given or received and the vehicle 100 travels forward through inertia with the engine 160 stopped will be taken into account. In this case, as shown in FIG. 2, the rotational speed NE of the engine 160 is equal to zero. The rotational speed MRN2 of the motor-generator 135 (an MG2), which is in a state of positive rotation, and the rotational speed MRN1 of the motor-generator 130 (an MG1), which is in a state of negative rotation, are balanced with each other.

In this state, as shown in FIG. 3, the control signal PWI1 for imparting a positive torque to the motor-generator 130 is supplied from the ECU 300. That is, the motor-generator 130 is caused to perform an electric power generation operation. Thus, the rotational speed of the motor-generator 130 decreases to approach zero.

At this moment, since no electric power for charging the electric storage device 110 can be supplied, an overvoltage may be applied to the components contained in the PCU 120 due to the electric power generated by the motor-generator 130 if no measure is taken. Thus, as in the case of the motor-generator 130, the control signal PWI2 for imparting a positive torque to the motor-generator 135 is supplied. Thus, the electric power generated by the motor-generator 130 is consumed by the motor-generator 135, so that the balance of energy is maintained.

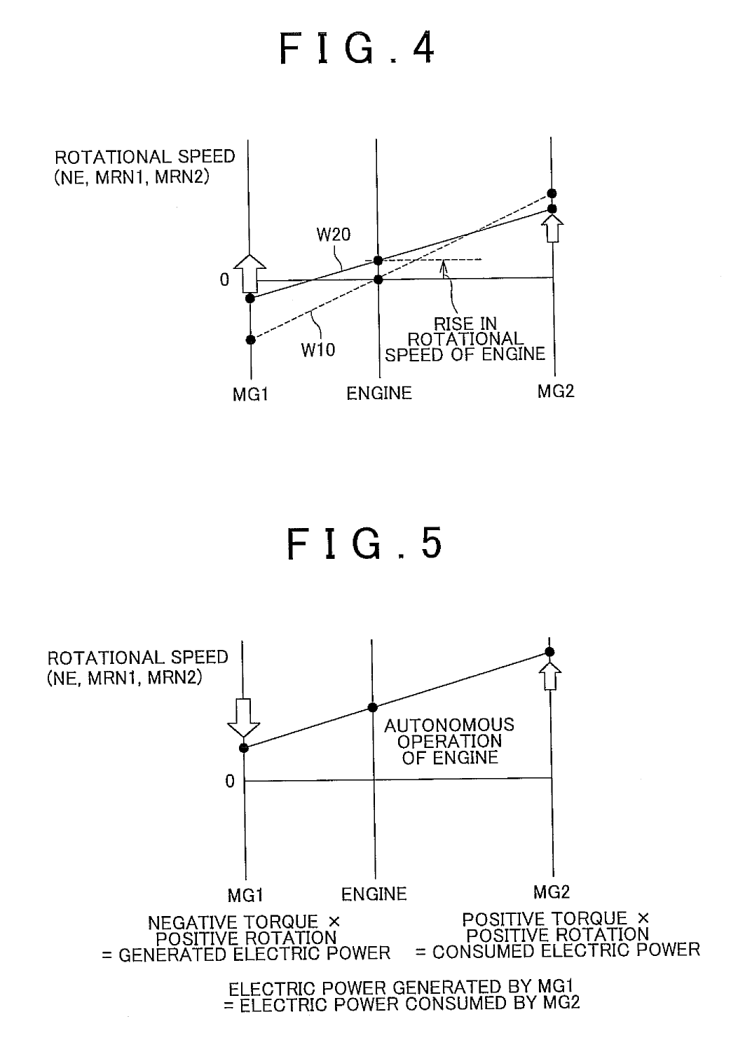

Then, as shown in FIG. 4, a broken straight line W10 makes a shift to a solid straight line W20, and the rotational speed NE of the engine 160 rises. Then, when the rotational speed NE rises to a rotational speed that allows the engine 160 to be started, fuel is injected into cylinders of the engine 160 to start the engine 160.

When the engine 160 is started to be brought into an autonomous operation state, torque command values are set for the motor-generators 130 and 135 such that the electric power generated by the motor-generator 130 and the electric power consumed by the motor-generator 135 are balanced with each other, as shown in FIG. 5. The control signals PWI1 and PWI2 based on the command values are then output from the ECU 300. In this manner, even in the case where no electric power from the electric storage device 110 can be given or received, the generated electric power and the consumed electric power do not become out of balance with each other. Further, the battery-less traveling of the vehicle can be realized while stabilizing the rotational speeds of the motor-generators 130 and 135.

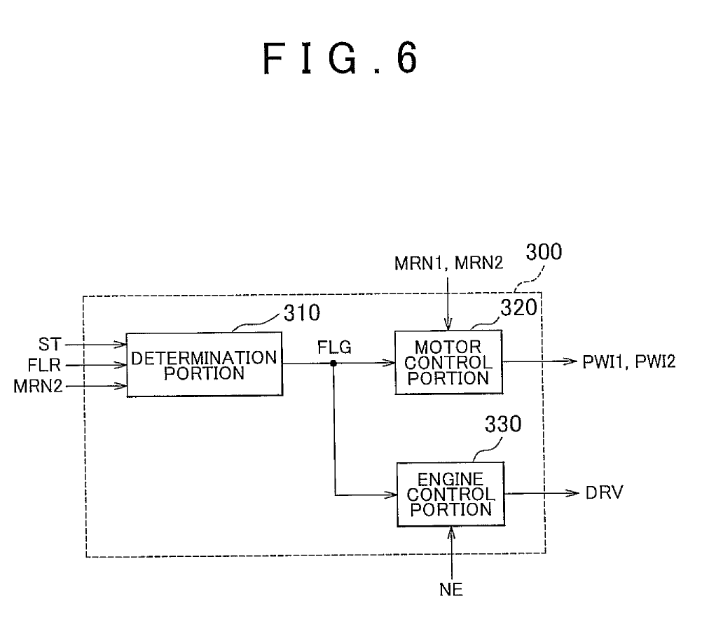

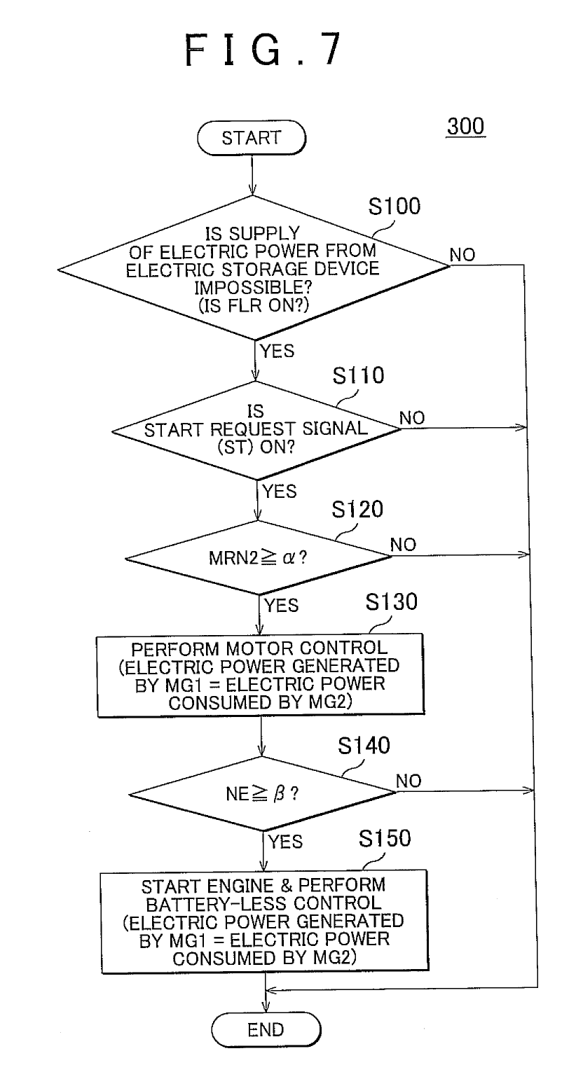

FIG. 6 is a functional block diagram for explaining the engine start control performed by the ECU 300 in this embodiment of the invention. Each of functional blocks mentioned in the functional block diagram of FIG. 6 is realized through the execution of a hardware or software processing by the ECU 300.

Referring to FIGS. 1 and 6, the ECU 300 includes a determination portion 310, a motor control portion 320, and an engine control portion 330.

The determination portion 310 receives the start request signal ST for requesting the start of the engine 160 on the basis of an operation by the user, a failure signal FLR indicating that no electric power can be supplied from the electric storage device 110 due to the occurrence of a malfunction, and the rotational speed MRN2 of the motor-generator 135. It should be noted herein that the failure signal FLR is, for example, a signal based on a determination made in accordance with the voltage VB of the electric storage device 110, the current IB, and the state of the SMR 115.

The determination portion 310 determines, on the basis of these pieces of information, whether or not no electric power can be supplied from the electric storage device 110 and an operation of starting the engine 160 has been performed by the user in this state. Furthermore, the determination portion 310 determines, on the basis of the rotational speed MRN2 of the motor-generator 135, whether or not the vehicle speed is equal to or higher than a predetermined speed.

Then, when the aforementioned conditions are fulfilled, the determination portion 310 sets a start request flag FLG on, and outputs this flag to the motor control portion 320 and the engine control portion 330.

The motor control portion 320 receives the start request flag FLG from the determination portion 310, and the rotational speeds MRN1 and MRN2 of the motor-generators 130 and 135. When the start request flag FLG is set on, the motor control portion 320 generates the control signals PWI1 and PWI2 such that the rotational speed NE of the engine 160 rises to a rotational speed that allows the engine 160 to be started and that the electric power generated by the motor-generator 130 and the electric power consumed by the motor-generator 135 become balanced with each other, and thus controls the inverters 122 and 123. Further, after the start of the engine 160, the motor control portion 320 controls the inverters 122 and 123 in a manner such that the electric power generated by the motor-generator 130 and the electric power consumed by the motor-generator 135 are balanced with each other, while a required driving force is output on the basis of the operation by the user.

The engine control portion 330 receives the start request flag FLG from the determination portion 310, and the rotational speed NE of the engine 160. The engine control portion 330 outputs the control signal DRV for the engine 160 including pieces of information such as a fuel injection amount, and thus starts the engine 160, in response to a state where the start request flag FLG is set on and the rotational speed NE of the engine 160 reaches the predetermined rotational speed that allows the engine 160 to be started due to the motor-generators 130 and 135.

When an autonomous operation is performed after the process of starting the engine 160 is completed, the engine control portion 330 controls the engine 160 such that a desired torque is output, on the basis of, for example, an amount of operation of an accelerator pedal by a user.

FIG. 7 is a flowchart for explaining the details of an engine start control processing performed by the ECU 300 in this embodiment of the invention. A program stored in advance in the ECU 300 is called up from a main routine and executed on a predetermined cycle, so that the processing of the flowchart shown in FIG. 7 is realized. Alternatively, some or all of the steps may be realized by a dedicated piece of hardware (an electronic circuit).

Referring to FIGS. 1 and 7, the ECU 300 determines in step (which will be hereinafter abbreviated as S) 100 whether or not there is a malfunction that makes it impossible to supply an electric power from the electric storage device 110.

When there is no malfunction that makes it impossible to supply an electric power from the electric storage device 110 (NO in S100), the motor-generators 130 and 135 can be driven through the use of the electric power from the electric storage device 110, and the engine 160 can also be started using the motor-generator 130. Thus, there is no need to perform this control. Therefore, the ECU 300 terminates the processing, and returns the processing to the main routine.

When there is a malfunction that makes it impossible to supply an electric power from the electric storage device 110 (YES in S100), the processing is advanced to 5110. In this step, the ECU 300 then determines whether or not a request to start the engine 160 has been made by the user (whether or not the start request signal ST is on).

When no request to start the engine 160 has been made (when the start request signal ST is off) (NO in S110), there is no need to start the engine 160. Therefore, the ECU 300 terminates the processing, and returns the processing to the main routine.

When there is a request to start the engine 160 (when the start request signal ST is on) (YES in S110), the processing is advanced to 5120. In this step, the ECU 300 determines whether or not the rotational speed MRN2 of the motor-generator 135 is equal to or higher than a predetermined reference speed α, thereby determining whether or not the vehicle speed is equal to or higher than a reference vehicle speed.

When the rotational speed MRN2 is lower than the predetermined reference speed α (NO in S120), the control of the motor-generators 130 and 135 does not make it possible to raise the rotational speed NE of the engine 160 to the engine rotational speed that allows the engine 160 to be started. Therefore, the ECU 300 terminates the processing, and returns the processing to the main routine.

When the rotational speed MRN2 is equal to or higher than the predetermined reference speed α (YES in S120), the processing is advanced to 5130. In this step, while an electric power is generated by the motor-generator 130, the generated electric power is consumed by the motor-generator 135 to raise the rotational speed NE of the engine 160 while canceling a reactive force. The ECU 300 then determines in 5140 whether or not the rotational speed NE of the engine 160 has risen to become equal to or higher than a threshold β that allows the engine 160 to be started.

When the rotational speed NE of the engine 160 is lower than the threshold β (NO in S140), the engine 160 still cannot be started. Therefore, the ECU 300 returns the processing to the main routine, and waits for the rotational speed NE to reach the threshold β.

Then, when the rotational speed NE of the engine 160 becomes equal to or higher than the threshold β (YES in 5140), the processing is advanced to 5150. In this step, the ECU 300 starts the engine 160, and starts battery-less control such that the electric power generated by the motor-generator 130 and the electric power consumed by the motor-generator 135 become balanced with each other.

Through the execution of the control in accordance with the foregoing processing, even in the case where the supply of an electric power from the electric storage device is impossible in the hybrid vehicle, when the hybrid vehicle is at a predetermined vehicle speed, the engine can be started. Thus, even in the case where the electric power from the electric storage device is shut off due to a malfunction while the vehicle is traveling in the EV mode, the engine can be started to allow the vehicle to travel in a retreating manner.

It should be noted that although the configuration in which the two motor-generators are provided has been mentioned as an example in the foregoing description, it is also appropriate to adopt a configuration in which one or three or more motor-generators are provided as long as the configuration makes it possible to generate an electric power through the use of a rotational force of the driving wheels and raise the rotational speed of the engine. It should be noted, however, that in the case where there is only one motor-generator, it is necessary to additionally provide a component (e.g., a resistor or a capacitor) that consumes or stores the electric power generated by the motor-generator or to consume the electric power through the use of an auxiliary load, in order to prevent an overvoltage from being applied to the components. Further, as regards the configuration for coupling the motor-generators to the engine as well, it is also possible to adopt various configurations. For example, the object coupled to each of the gears of the planetary gear may be made different. Further, the motor-generators may also be coupled to the engine via frictional engagement elements such as clutches or the like.

The embodiment of the invention that has been disclosed in the specification is to be considered in all respects as illustrative and not restrictive. The technical scope of the invention is defined by claims, and all changes which come within the meaning and range of equivalency of the claims are therefore intended to be embraced therein.

What is claimed is: (: US)

1. A vehicle comprising:
an electric storage device;
an internal combustion engine;
an electric drive portion that generates a driving force of the vehicle through use of an electric power from the electric storage device, and generates an electric power through use of a rotational force of driving wheels of the vehicle; and
a control device that is configured to control a driving force from the internal combustion engine and the driving force from the electric drive portion in a cooperative manner to cause the vehicle to travel, wherein
the control device causes the electric drive portion to perform an electric power generation operation to raise a rotational speed of the internal combustion engine and start the internal combustion engine, upon receipt of a request to start the internal combustion engine in a state where the electric power from the electric storage device is unable to be used to drive the electric drive portion and a vehicle speed is equal to or higher than a predetermined reference vehicle speed.

2. The vehicle according to claim 1, wherein
the electric drive portion includes a first electric rotating machine that generates the electric power through use of the rotational force of the driving wheels of the vehicle, and a second electric rotating machine that generates the driving force of the vehicle through use of the electric power from the electric storage device, and
the control device causes the first electric rotating machine to perform the electric power generation operation to raise the rotational speed of the internal combustion engine and start the internal combustion engine, upon receipt of the request to start the internal combustion engine in a state where the electric power from the electric storage device is unable to be used to drive the second electric rotating machine and the vehicle speed is equal to or higher than the reference vehicle speed.

3. The vehicle according to claim 2, wherein
the control device causes the second electric rotating machine to consume the electric power generated by the first electric rotating machine when starting the internal combustion engine.

4. The vehicle according to claim 2, wherein
the control device causes the second electric rotating machine to consume the electric power generated by the first electric rotating machine when causing the first electric rotating machine to perform the electric power generation operation to raise the rotational speed of the internal combustion engine.

5. The vehicle according to claim 1, wherein
the control device starts fuel injection to start the internal combustion engine when the rotational speed of the internal combustion engine becomes equal to or higher than a predetermined threshold.

6. A control method for a vehicle that includes an electric storage device, an internal combustion engine, and an electric rotating machine that generates a driving force of the vehicle through use of an electric power from the electric storage device and generates an electric power through use of a rotational force of driving wheels of the vehicle, wherein the vehicle is caused to travel by controlling a driving force from the internal combustion engine and the driving force from the electric rotating machine in a cooperative manner, the control method comprising:
determining whether or not the electric power from the electric storage device is able to be used to drive the electric rotating machine;
determining whether or not a vehicle speed is equal to or higher than a predetermined reference vehicle speed;
causing the electric rotating machine to perform an electric power generation operation, upon receipt of a request to start the internal combustion engine in a state where the electric power from the electric storage device is unable to be used to drive the electric rotating machine and the vehicle speed is equal to or higher than the reference vehicle speed; and
starting fuel injection to start the internal combustion engine when a rotational speed of the internal combustion engine becomes equal to or higher than a predetermined threshold.

7. The control method according to claim 6, wherein
the electric rotating machine includes a first electric rotating machine that generates the electric power through use of the rotational force of the driving wheels of the vehicle, and a second electric rotating machine that generates the driving force of the vehicle through use of the electric power from the electric storage device,
it is determined whether or not the electric power from the electric storage device is able to be used to drive the first electric rotating machine and the second electric rotating machine, and
the first electric rotating machine is caused to perform the electric power generation operation, upon receipt of the request to start the internal combustion engine in a state where the electric power from the electric storage device is unable to be used to drive the second electric rotating machine and the vehicle speed is equal to or higher than the reference vehicle speed.

8. The control method according to claim 7, wherein
the second electric rotating machine is caused to consume the electric power generated by the first electric rotating machine when causing the first electric rotating machine to perform the electric power generation operation.
